(19) United States
(12) Patent Application Publication
(10) Pub. No.: US 2013/0266301 A1
(43) Pub. Date: Oct. 10, 2013

(54) Inflatable Portable Structure

(71) Applicant: Brian Hedenberg, Bedford, TX (US)

(72) Inventor: Brian Hedenberg, Bedford, TX (US)

(21) Appl. No.: 13/359,355

(22) Filed: Apr. 5, 2012

(51) Int. Cl. E04H 15/54; G03B 15/00

(52) U.S. Cl. 396/1; 135/115

(57) ABSTRACT

This disclosure relates to an air inflatable enclosure comprising of non-supported sheets of triple layer polyethylene, having a thickness between 5-10 mils, and heat welded edges being anchored to the base material (such as earth and the like) for stability. The structure has no poles, metal or fiberglass frame, inflatable ribbing or tubes. With a high tensile strength polyethylene shell, with a thickness between 5-10 mils, provided a low cost, highly stable, lighter, more portable, and more affordable air inflatable enclosure.

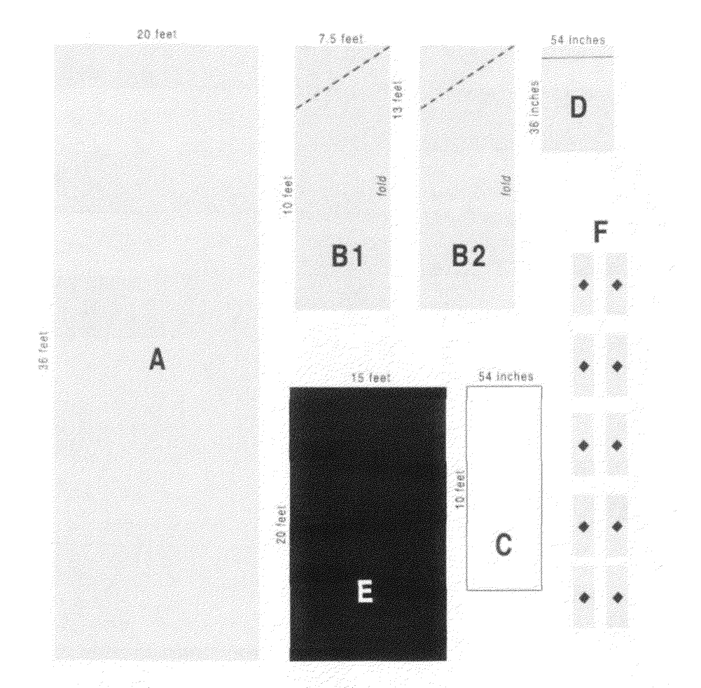

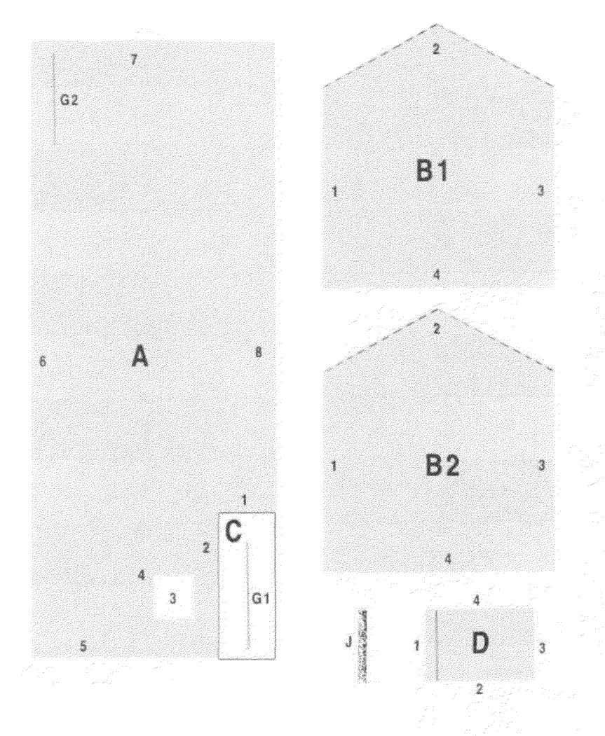

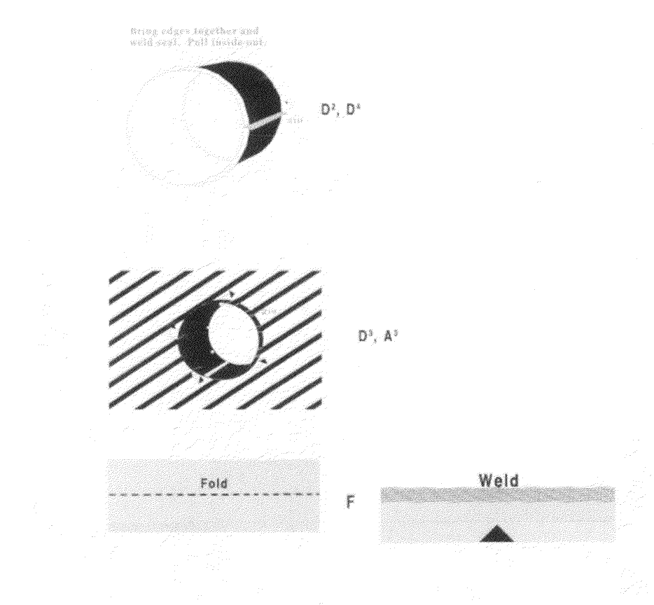

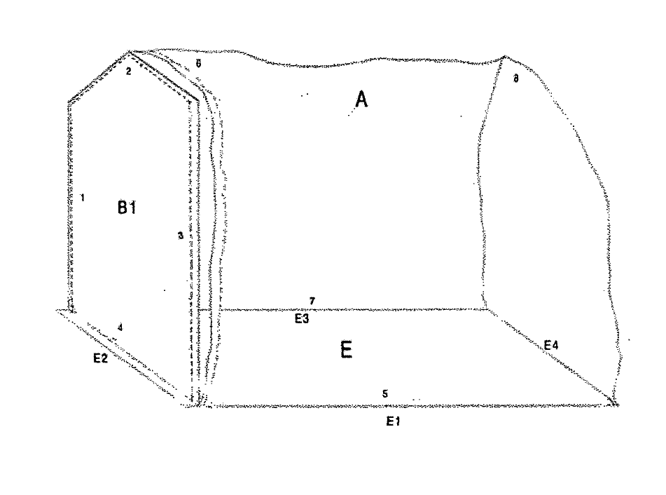

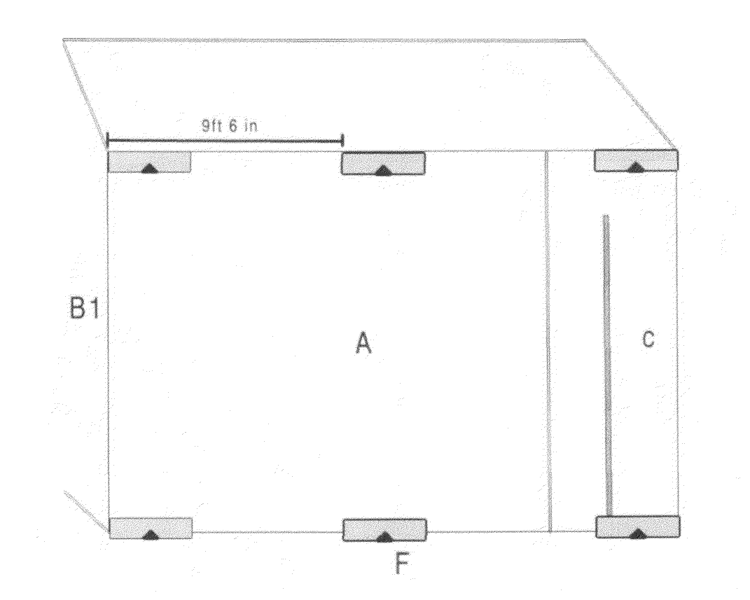

This Application claims priority to Provisionary Application 61/436,576 filed Jan. 26, 2011

### REFERENCES CITED

| | | | |
|---|---|---|---|
| 3,769,763 | November 1973 | Kwake | 258,469 |
| 3,999,333 | December 1976 | Amarantos | 631,859 |
| 4,103,369 | August 1978 | Riordan | 772,452 |
| U.S. Pat. No. | July 2001 | Swetish et al | 09/307,507 |
| 6,260,306B1 | | | |
| US2004/0159347A1 | September 2004 | Brown at el | 10/771,988 |
| US2006/0285836A1 | December 2006 | Coppola | 10/568,656 |

### BACKGROUND

1. Field of Invention

The field of invention is photography.

2. Background of Invention

For both still and motion photography, having access to a studio can be essential. Most people attempt to set up studios in their home and are restricted by space and ceiling height. Rental studios can prove to be extremely costly. In some case, photographers, filmmakers, or media need the ability to have a light weight, extremely portable, compact studio to use at a moments notice.

The Inflatable Portable Structure acts as a shell that can be used in various ways. Unlike the dome shape, transparent sides (or bubble) of the “Inflatable Photographic Structure” (Coppola Ser. No. 10/568,656) in which the inside of the studio is lit from outside, the user has a complete light blocking environment with no curved walls or ceiling creating dead space. The background the user chooses to use often demands the need for a rectangular shaped space. Curved space uses more material that creates more needed space, heavier transport, and more air. The concept of the Inflatable Portable Structure is to create a separation from outside and the inside. The only light permitted inside is through the diffused door panel to create ambient light for safety and does not affect photography.

The portability and size of the Inflatable Portable Structure allows the user to have a compact case of approximately 6.25 square feet (30 inches by 30 inches by 12 inches), weighing only 40 pounds, and easily transport it to any location with ease. Once unfolded and affixed to the base (or earth), and fastened to the fan, or ventilator included) the structure erects to 20 feet by 15 feet by 13 feet high in a matter of minutes. The “Photographic Shooting Tent” (by Brown Ser. No. 10/771,988) is considerably smaller meant for small object and requires no air.

The “Inflatable Shelter” (by Swetish Ser. No. 09/307,507) and “Inflatable Enclosure” (by Amarantos Ser. No. 631,859) use inflatable tubes supported by a membrane that creates more weight, down not support high ceilings or large structures and can be difficult to repair. The fan in the “Inflatable Portable Structure” pushes 7,700 cubic feet of air per minute into the structure creating more air pressure inside than outside. This difference in air pressure makes the structure very resistant to outside forces, such as weather.

The triple layer UV coated fire retardant polyethylene helps control the environmental temperature and condition. The ventilator is very quiet (less than 85 db) and creates little to no noticeable wind current inside the structure. However, the ventilator circulates fresh air from the outside. The “Inflatable Structure” (by Riordan Ser. No. 772,452) once again uses a half sphere or rounded structure that requires more space and refers its use “as a readily portable structure for providing a separate completely enclosed space within a room. It is not designed to withstand weather elements or possess the material best suited for varying temperatures. Nor does it possess the thick resistant flooring designed for outdoor terrain.

Unlike the Air Inflatable Structure” (by Kwake Ser. No. 258,469), the ease of use, setup, breakdown, and portability also open the Inflatable Portable Structure to several other industries and demands, such as VIP Tent, Inflatable classroom, clinic, workshop, chroma-studio, dressing room, triage/medical tents, etc. The size may vary for each demand, however the concept, design, and utility remain the same. The “Air Inflatable Structure” is a series of webbing and heavy 30-120 mil non-stretchable strips fused to 10-20 mil plasticized polyvinyl chloride or polyvinyl acetate plastic sheets. Its purpose primarily to cover pools and tennis courts, but not portable or compact.

### SUMMARY

The Inflatable Portable Structure (a.k.a. Expandable Photo Studio) was designed and implemented, by Brian Hedenberg, in June 2010 due to the economic conditions of the United States at that time. Photo studio rental prices were high. The “Inflatable Portable Structure” was to provide anyone with a studio who lacked the means to either rent or build a studio, or needed access to a portable photo studio. Folded up, it is 30 inches by 30 inches by 12 inches and only weighs 45 pounds. With the use of a 24-inch industrial drum fan, the unit inflates to a 300 square foot structure in approximately 4 minutes (measuring 20 feet×15 feet×13 feet high). The larger version is double the size folded up and expands to 600 square feet (measuring 20 feet×30 feet×13 feet high) is approximately 10 minutes. Unlike other patented structures made of heavy PVC vinyl, with sewn seams, internal skeletal structures, and longer inflation periods, the “Inflatable Portable Structure” is lighter, more portable, and less expensive. The fan (which we include with the unit) is extremely quiet, and pushes 7,700 cubic feet of air per minute into the unit making it durable in winds up to 20 miles an hour, rain, sleet, and partially cloudy days (a problem photographers struggle with). The “Inflatable Portable Structure” is made of a 6-mil three-layer UV coated fire retardant polyethylene material heat welded to the floor, which is made of a 10-mil polyethylene material. The entrances comprise of 7-foot heavy-duty reversible zipper door(s). Due to the resourceful, durable, and portable nature of the inflatable unit, several other uses for the stricture have arisen comprising of Greenrooms and VIP tents for events, classrooms and workshops for schools and retail outlets, workshops, catering tents, mobile offices, and triage/medical tents. The “Inflatable Portable Structures” can be setup on virtually any surface (as long as there is a means to secure the structure to the ground, or stationary object, to keep the structure from moving in strong winds).

The “Inflatable Portable Structure” also has the option of having a diffused roof and a cover that can be fastened on to create total darkness. Other accessories might include an air-lock to move large objects, sets, or automobiles inside while the unit is fully inflated, or a chroma-screen attachment inside for special effects filmmakers or photography.

### BRIEF DESCRIPTIONS OF DRAWINGS

1. Assemble 1 is the assembly pattern noting each edge

2. Assemble 2 is the manufacturing of the “Fan Tunnel” and its attachment to the structure body

3. Assemble 3 is the welding diagram for the structure body

4. Assemble 4 is the welding diagram for the “Wind Tabs”

5. Drawing 1 is the pattern of the material to be cut and welded

### MATERIALS/PATTERN —(SEE ATTACHMENT “PATTERN 1”)

A. 36 feet long by 20 feet wide 6 mil polyethylene white exterior, UV coated, completely light blocking, fire retardant, three layer material to be used as the BODY.

B. Two 13 feet high by 15 feet wide 6 mil polyethylene white exterior, UV coated, completely light blocking, fire retardant, three layer material to be used as the SIDES.

C. 54 inch wide by 10 feet long 6 mil polyethylene white exterior, UV coated, completely light blocking, fire retardant, three layer material to be used as the DOOR PANEL.

D. 54 inch wide by 36 inch long 6 mil polyethylene white exterior, UV coated, completely light blocking, fire retardant, three layer material to be used as the FAN TUNNEL.

E. 20 feet long by 15 feet wide 10 mil black polyethylene material to be used as the FLOOR.

F. Twelve 14 inch wide by 4 inch wide 6 mil polyethylene white exterior, UV coated, completely light blocking, fire retardant, three layer material to be used as the WIND TABS.

G. Two 7 foot heavy duty reversible adhesive zippers (G1 & G2)

H. Six ½ inch heavy duty brass grommets

I. Twelve 1 foot ¼ inch carbon fiber rods

J. 54 inch by 2 inch canvas strap

K. Six ¼ inch elastic hoops attached to a 3 inch×½ inch nickel plated snap hooks

### Assembly Instruction—(See Attachment “Assemble 1”)

1. Fold pieces B1 and B2 (SIDES) in half, lengthwise. Measure up 10 feet opposite the fold and cut diagonally to the nearest folded corner, creating the peak for the SIDES.

2. Adhere one of the 7 foot zippers (G1) to the center of piece C (Diffused DOOR PANEL) 6 inches from the base with the zipper at the bottom in the closed position. Cut the Door Panel from the top of the zipper to the base forming the first DOOR OPENING.

3. On piece A (BODY), cut 10 feet along the length 54 inches in from the right side. Then cut 54 inches across from the right side to the top of the lengthwise cut forming a rectangle.

4. Heat weld piece C (DOOR PANEL) to piece A (Body) along A¹. Next, weld piece C to piece A along A².

5. Cut a square (A³) into piece A (BODY) approximately 11 inches from the base and 23 inches from the edge of A² forming the hole for the FAN TUNNEL.

6. Adhere one of the 7 foot zippers (G2) to the opposite end of piece A (BODY) on the opposite corner, 6 inches from the top of piece A with the zipper at the top in the closed position. Cut the Door Panel from the top of the zipper to the base forming the second DOOR OPENING.

7. Place piece J (CANVAS STRIP) on top of piece D along the edge of D¹. Fold the edge of D¹ over 2 inches cover piece J and heat weld.

8. Evenly space and fasten 6 grommets (pieces H) on top of the new 2 inch fold with the canvas piece in between (D¹).

9. (See attachment Assemble 2): Fold piece D (FAN TUNNEL) in half with edge D² to D⁴ and heat weld along the length of piece D forming the FAN TUNNEL. Turn the new FAN TUNNEL inside out.

10. (See attachment Assemble 2): Attach Piece D (FAN TUNNEL) edge D^{3 to} A⁴ (FAN TUNNEL OPENING) by heat welding the edges together.

11. (See attachment Assemble 3): Heat weld B1 (SIDE 1) to piece A (BODY) by welding the edge of A⁶ (starting on the corner closest to A⁷) to the edge of B1¹ (starting on the corner closest to B1⁴) up and over B1²and down along the edge of B1³. The weld should end with the corner of A⁶ (closest to edge A⁵) and the corner of B1³ (closest to B1⁴).

12. (See attachment Assemble 3): Heat weld B2 (SIDE 2) to piece A (BODY) by welding the edge of A⁸ (starting on the corner closest to A⁵) to the edge of B2¹ (starting on the corner closest to B2⁴) up and over B2² and down along the edge of B2³. The weld should end with the corner of A⁸ (closest to edge A⁷ and the corner of B2³ (closest to B2⁴).

13. (See attachment Assemble 3): Heat weld piece E¹ to A⁵ lengthwise. Then weld E² to B1⁴ lengthwise. Heat weld E³ to A⁷ lengthwise. Finally weld E⁴ to B2⁴ lengthwise, securing the FLOOR to the BODY and SIDES.

14. (See attachment Assemble 2): Fold each of the F pieces MIND TABS) in half lengthwise and weld a ½ inch heat weld along the length of the lose ends. 5 inches in from each side, cut into the fold approximately 1 inch diagonally toward the center.

15. (See attachment Assemble 4): Heat weld the first WIND TAB (piece F) lengthwise along the bottom edge in the bottom left corner of the BODY (where piece A⁵ and piece E¹ are welded together) closest to the edge where piece B1 (SIDE) and piece A (BODY) are welded together.

16. (See attachment Assemble 4): Heat weld the second WIND TAB (piece F) lengthwise along the top edge in the top left corner of the body (piece A) closest to the edge where piece B1 (SIDE) and piece A (BODY) are welded together.

17. (See attachment Assemble 4): Heat weld the third WIND TAB (piece F) lengthwise along the top edge in the top right corner of the DOOR PANEL (piece C) closest to the edge where piece B2 (SIDE) and piece C (DOOR PANEL) are welded together.

18. (See attachment Assemble 4): Heat weld the forth WIND TAB (piece F) lengthwise along the bottom edge in the bottom right corner of the DOOR PANEL (where piece C and piece E¹ are welded together) closest to the edge where piece B2 (SIDE) and piece C (DOOR PANEL) are welded together.

19. (See attachment Assemble 4): Heat weld the fifth WIND TAB (piece F) lengthwise along the top edge in the center of the top of the BODY (piece A) starting 9 feet 6 inches from the edge where piece B1 (SIDE) and piece A (BODY) are welded together.

20. (See attachment Assemble 4): Heat weld the sixth WIND TAB (piece F) lengthwise along the bottom edge in the center of the bottom of the BODY (piece A) starting 9 feet 6 inches from the edge where piece B1 (SIDE) and piece A (BODY) are welded together.

21. (See attachment Assemble 4): Heat weld the seventh WIND TAB (piece F) lengthwise along the bottom edge in the bottom left corner of the BODY (where piece A⁷ and piece E³ are welded together) closest to the edge where piece B2 (SIDE) and piece A (BODY) are welded together.

22. (See attachment Assemble 4): Heat weld the eighth WIND TAB (piece F) lengthwise along the top edge in the top left corner of the body (piece A) closest to the edge where piece B2 (SIDE) and piece A (BODY) are welded together.

23. (See attachment Assemble 4): Heat weld the ninth WIND TAB (piece F) lengthwise along the top edge in the top right corner of the DOOR PANEL (piece A) closest to the edge where piece B1 (SIDE) and piece A (BODY) are welded together.

24. (See attachment Assemble 4): Heat weld the tenth WIND TAB (piece F) lengthwise along the bottom edge in the bottom right corner of the BODY (piece A) closest to the edge where piece B1 (SIDE) and piece A (BODY) are welded together.

25. (See attachment Assemble 4): Heat weld the eleventh WIND TAB (piece F) lengthwise along the top edge in the center of the top of the BODY (piece A) starting 9 feet 6 inches from the edge where piece B2 (SIDE) and piece A (BODY) are welded together.

26. (See attachment Assemble 4): Heat weld the twelfth WIND TAB (piece F) lengthwise along the bottom edge in the center of the bottom of the BODY (piece A) starting 9 feet 6 inches from the edge where piece B2 (SIDE) and piece A (BODY) are welded together.

27. Thread each elastic hoop through a grommet on the FAN TUNNEL, then back through itself pulling it taught. Then thread it through the swivel-eye of the hook, pull it up over the hook end and pull it taught so as to loop through the Grommet and the swivel-eye of the hook. The hook can now be used to stretch around the body of the drum fan and attach to the grill in the back of the fan. Repeat with the remaining elastic hoops and grommets on the FAN TUNNEL.

1. What I claim as my invention is an inflatable structure to be used as a photography studio and/or for public events, comprising of a single exterior barrier of light blocking and/or diffused polyethylene or vinyl that is thinner than 0.25 millimeters in thickness and weighs less than 100 pounds, as a whole, has no skeletal or interior chambers used for structural support, and erects fully in less than 10 minutes when filled with outside air through the use of a ventilator.
